(19) United States
(12) Patent Application Publication
(10) Pub. No.: US 2009/0149691 A1
(43) Pub. Date: Jun. 11, 2009

(54) ECOFRIENDLY OIL-BINDING AGENT FOR USE ON LIQUIDS AND SOILS

(76) Inventor: Harald Weirich, Oberherrn-Berus (DE)

Correspondence Address: K.F. ROSS P.C., 5683 RIVERDALE AVENUE, SUITE 203 BOX 900, BRONX, NY, 10471-0900, US

(21) Appl. No.: 12/302,056

(22) PCT Filed: May 23, 2007
(86) PCT No.: PCT/EP07/04552

§ 371 Date: Nov. 24, 2008

(30) Foreign Application Priority Data
May 24, 2006 (CH) 00867/06

(51) Int. Cl. A62D 3/30; B01J 20/26; C11D 3/37

(52) U.S. Cl. 588/313; 502/402; 510/188

(57) ABSTRACT

The invention relates to an environmentally friendly oil binding agent based on comminuted plastic or inorganic material, which is obtained for use as an adsorption material from the comminuted plastic or inorganic material and at least one vegetable oil, vegetable oil constituent or vegetable oil derivative. The plastic can be polystyrene, preferably in fine chips, and the vegetable oil is selected from rapeseed oil, sunflower oil, soya oil, castor oil, olive oil, linseed oil, coconut oil, palm oil, a constituent or derivative of said oils and mixtures thereof. In addition, the oil binding agent can contain a filler, such as silica sand. The areas of application for the oil binding agent are manifold and relate to the binding of oil on water, the cleaning of water in harbour basins or similar, in containers filled with liquid, the cleaning of oil-contaminated birds, the binding of oil on street surfaces and sandy soil and the cleaning of oil containers. The invention also relates to a method for disposing of oils of petrochemical or vegetable origin.

The invention relates to an ecofriendly oil-binding agent for use on liquids and soils.

Such a generic oil-binding agent became known through DE 41 19 193. DE 41 19 193 discloses an oil-binding agent based on a polystyrene foam or rigid foam in which the polystyrene foam is comminuted, e.g. by cutting, and has been coated with a vegetable oil. The vegetable oil wets the surface of the cut polystyrene foam particles, thereby considerably enhancing their properties. The basic idea was to provide an ecofriendly product made of a renewable raw material, preferably even a waste product from the production process for vegetable oil.

The binding agent obtained in this manner demonstrated exceptional affinity with respect to other oils, regardless of the type of oil, and was therefore suggested as a means for binding oil after accidents on the water or on land, for cleaning water, for cleaning containers, or for picking up leaked oil. The other oil to be picked up by the oil-binding agent was absorbed as if by a blotter by the rigid polystyrene foam that was modified vegetable-oil coating.

Moreover, an additional advantage of the known oil-binding agent was that, because of the vegetable-oil coating on the rigid polystyrene foam, the binding agent was surprisingly easier to handle in terms of a much higher bulk density and significantly improved pourability.

Proceeding from this prior art, the object of the present invention was to provide an improved binding agent that is even more ecofriendly, that does not itself release the bound oil over the long term, and that has more uses.

This object is attained using an ecofriendly oil-binding agent based on comminuted plastic or an inorganic mineral that can be obtained as an adsorption union from comminuted plastic or an inorganic mineral and at least one vegetable oil, vegetable oil constituent, or vegetable oil derivative.

The term “comminution” should be broadly construed. The particle size is a function inter alia of the type of plastic or mineral used and the desired usage as well as the comminution method used. Cutting or tearing methods can be used, the plastic or the mineral being cut or brushed into pieces, and in precisely the same manner the starting material can be a granulate having a grain size to be determined in advance as a function of usage purpose. In the framework of the invention, the term “comminuted material” therefore also includes a granulate with any grain size.

When using cut or brushed plastic material, particle sizes smaller than approx. 3 mm, preferably in a range from 1.5 to 0.5 mm, have proven useful.

If a granulate is used, the particle size is based on the type of production method selected and the application in the usual manner known to one skilled in the art.

Foamed polystyrene can be used for the plastic. Foamed polystyrene has the advantage that it is inexpensive to produce. A modified polystyrene can also be used for certain applications. Foamed pearlite can be cited as one of the inorganic minerals, for instance. It has a bulk weight similar to that of foamed polystyrene.

The vegetable oil for forming the adsorption union and thus the inventive binding agent is preferably selected from rapeseed oil, sunflower oil, soya oil, castor oil, olive oil, linseed oil, coconut oil, palm oil, or a constituent, derivative, or mixtures thereof. At this point it should be noted that this is an exemplary listing of the pertinent vegetable oils and that fundamentally any vegetable oil can be used for the purposes of the present invention. Particularly preferred are vegetable oil residues that cannot be used in another manner and that otherwise must be disposed of, such as occur e.g. during production of cooking oils.

Particularly the esters and glycerol esters of the many unsaturated fatty acids should be stressed as derivatives of the vegetable oil. The fatty acids themselves are mostly even-numbered, straight-chain, aliphatic monocarboxylic acids with chain lengths from C₄ to C₂₄.

The inventively produced oil-binding agent is characterized by a low bulk density and enhanced pourability. There is a drastic reduction in dust formation and a reduction in the electrostatic charge.

In large surface area applications of the inventive oil-binding agents, e.g. outdoors, the binding agent can drift, especially given unfavorable wind conditions. Therefore it can also contain a filler. The filler can be selected for instance from fine-grained silica sands, specification of this filler being merely exemplary in nature. One skilled in the art is moreover familiar with a plurality of other fillers that can also contribute to increasing the density of the oil-binding agent. Tests have demonstrated that its oil-binding capacity is in no way adversely affected by this.

The object mentioned above is also attained using inventive applications of the oil-binding agent. Among these are the application of oil to liquids for binding, where the binding of oil on expansive water surfaces, as is necessary e.g. after tanker accidents, is stressed. The inventive oil-binding agent is also well suited for routine and unplanned cleaning of water in harbors or in other containers and receptacles filled with liquids.

With respect to the extent of environmental pollution of land and the animal world that is associated with a tanker accident, the suitability of the oil-binding means for cleaning oil-soaked living things, in particular birds of all types, should be stressed. This could be impressively demonstrated in tests on oil-soaked birds.

In addition, the inventive use of the oil-binding agent is also meaningful for binding oil to surfaces made of solids. The surfaces made of solids can be largely closed soil coverings. Elimination of used oil from the soil at service stations can be cited as an example thereof. In addition, its use for (final) cleaning of oil containers after they have been emptied is of substantial practical importance.

The surfaces made of solids that are to be cleaned can also be soils that are largely made of movable solids, such as sandy soils. These can especially include, but are not limited to, contaminated sand beaches after a tanker accident.

The oil to be bound is preferably a crude oil or other residual oil that can also be a vegetable oil itself. No limit is placed on the bindability of the oil-binding agent.

Finally, the exemplary listing of various possible inventive uses also includes use of the oil-binding agent for picking up leakage oil of all types, which also has great practical significance.

In laboratory and long-term experiments it was possible to demonstrate convincingly that when polystyrene foam particles are loaded with a vegetable oil and then used for binding crude oil, not only was the crude oil absorbed in a very short period of time, but also uniform black spheres having a diameter of approx. 2-4 cm were created that have surprising stability against pressure. That is, they did not release the crude oil they absorbed, even under considerable pressure.

The object is also attained using a method for disposing of oils that have a petrochemical or vegetable origin in which in a first method step a plastic or inorganic material is initially cut or finely comminuted and is allowed to react with at least one vegetable oil, vegetable oil constituent, or vegetable oil derivative in order to form an oil-binding agent through adsorption, and in which then in a second method step the thus modified plastic or mineral is allowed to further react with any oil, oil derivative, or oil constituent while largely completely absorbing the latter.

This inventive method makes use of the principle that after the first method step, i.e. after the plastic or inorganic mineral is coated with the vegetable oil, vegetable oil constituent, or vegetable oil derivative, improved absorption capacity and an increase in the absorption volume is attained by the oil modification of the plastic or mineral surface in which now only “oil must come to oil”.

In the inventive oil adsorption method, the oil-binding agent is already finished and ready to use after performing the first method step. The second inventive method step, further coating with oil to be disposed of, does not occur until its application, i.e. when it is employed in practice. Then crude oil, which is an oil with petrochemical origin, or another oil contamination, e.g. from industrial accidents, can be bound to the plastic or mineral modified in accordance with the first method step.

The fact that a true chemical bond occurs due to the union of the plastic or mineral coated with the vegetable oil also influences the ecofriendliness of the oil-binding agent. Used or residual oil that has been absorbed is retained and is demonstrably not released to the environment over a period of years.

The invention shall be explained in greater detail in the following using illustrated embodiments and the attached drawing.

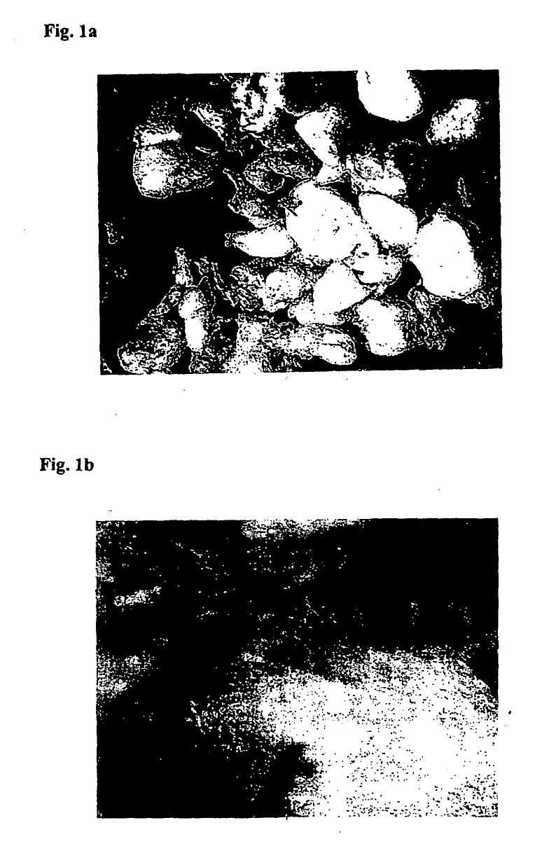

FIG. 1a is a microscope image of a polystyrene granulate coated with rapeseed oil, at 10× magnification;

FIG. 1b is a microscope image as in FIG. 1a, but at 57× magnification;

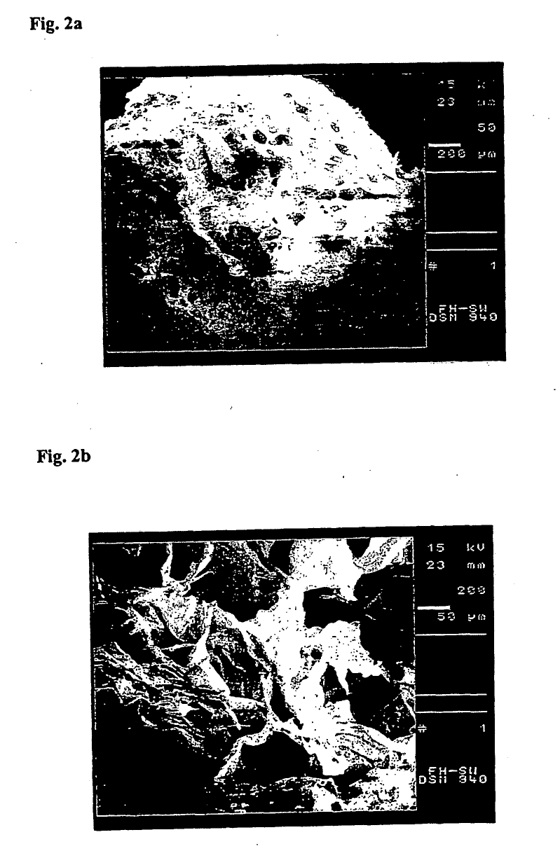

FIG. 2a is a scanning electron microscope image of a polystyrene granulate particle, coated with rapeseed oil, at 50× magnification;

FIG. 2b is an image in accordance with FIG. a, but at 200× magnification;

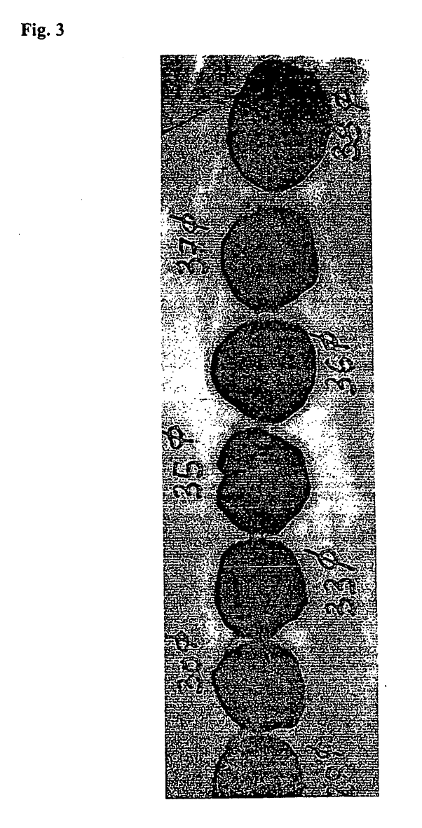

FIG. 3 is a spherical structure made of rigid polystyrene foam after the absorption of crude oil, with diameter in millimeters;

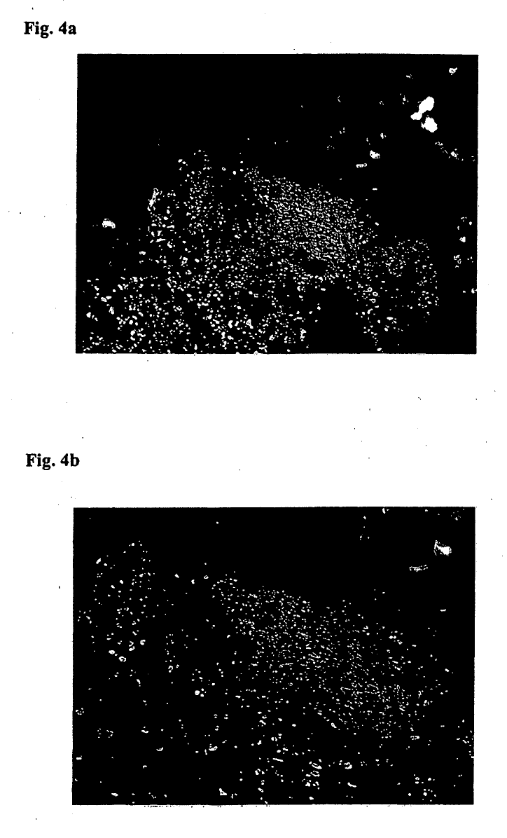

FIG. 4a is a microscope image of a polystyrene granulate coated with crude oil, at 32× magnification;

FIG. 4b is an illustration according to FIG. 4a, but at 57× magnification;

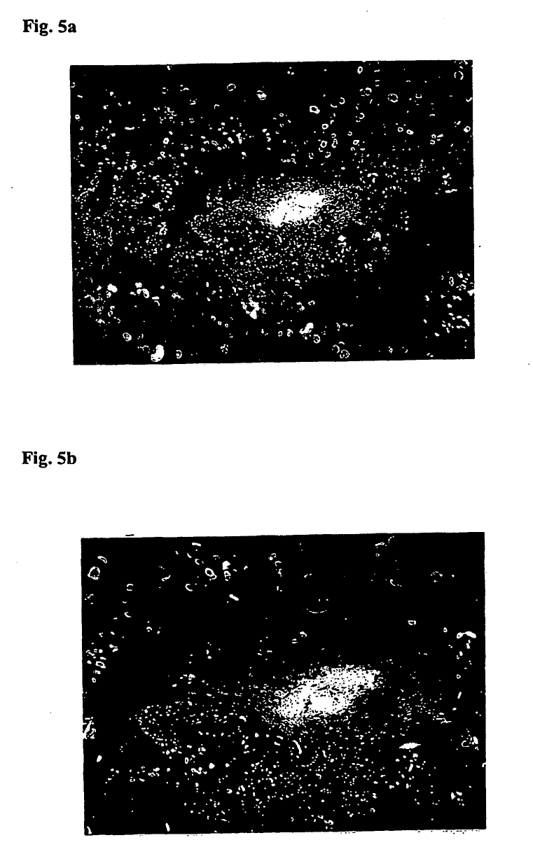

FIG. 5a is another microscope image of a polystyrene granulate coated with crude oil, at 32× magnification;

FIG. 5b is an image according to FIG. 5a, but at 57× magnification;

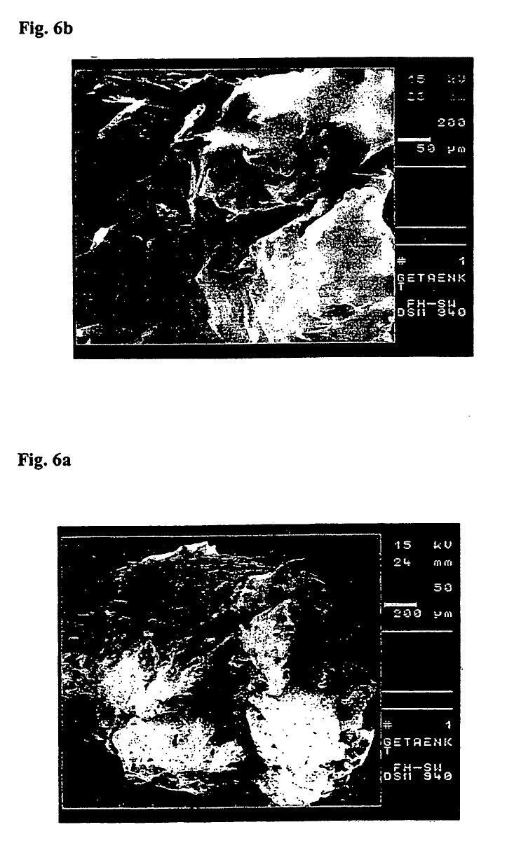

FIG. 6a is a scanning electron microscope image of a cross-section of a polystyrene granulate agglomerate, coated with crude oil, at 50× magnification;

FIG. 6b is an image according to FIG. 6a, but at 200× magnification; and,

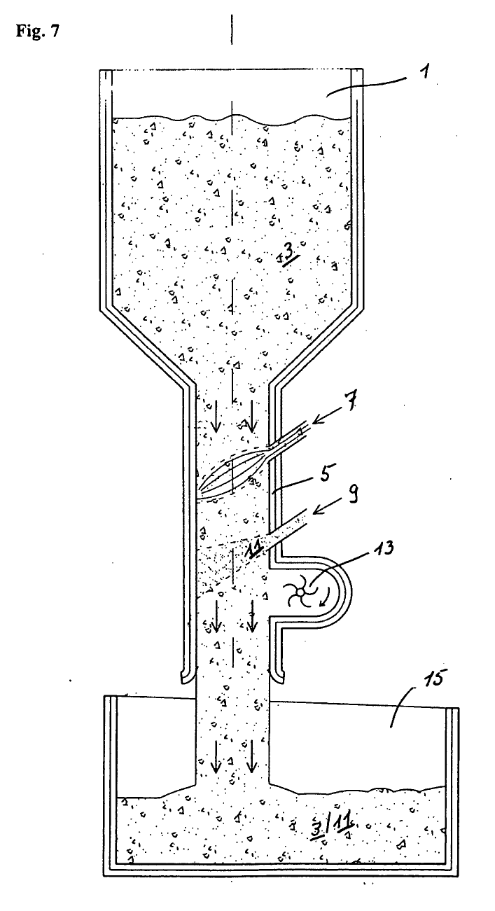

FIG. 7 is a section through a schematically depicted device for producing the inventive oil-binding agent with fillers.

### EXAMPLES

### Example 1

### Experiments on the Type of Bond Between Oil-Binding Agent and Adsorbate in the Form of Crude Oil

The plastic used for the purpose of this exemplary experiment is a rigid plastic foam made of polystyrene in the form of a polystyrene granulate. This polystyrene granulate is coated with rapeseed oil in that for 100 g of the granulate about 5 g oil in this illustrated embodiment is applied to the granulate by atomizing the oil. The polystyrene granulate is a granulate that is commercially available from BASF AG, Germany.

After the polystyrene granulate has been coated with the rapeseed oil, the granulate feels slightly sticky under strong pressure, but does not clump together.

The polystyrene granulate coated with the rapeseed oil in this manner was examined using an Olympus SZX 9 stereo microscope at 10× magnification and is shown here in FIG. 1a. A section of the same granulate coated with the rapeseed oil is shown in FIG. 1b, but at 57× magnification. The rapeseed oil coating is very apparent here.

The same views were also performed with a Zeiss DSM 940 digital scanning electron microscope. The results are shown in FIG. 2a at 50× magnification and in FIG. 2b at 200× magnification.

In one simple experimental arrangement comprising a glass cylinder filled with water and having a diameter of 40 cm and a height of 50 cm, crude oil was applied as a thin layer to the surface of the water such that a cohesive layer of oil resulted. Then cut polystyrene foam that was finely coated with rapeseed oil was distributed onto this surface. Within a brief period the crude oil disposed on the surface of the water was incrementally absorbed by the polystyrene foam coated with the rapeseed oil without the surface having been stirred or touched in any manner. The crude oil even reached quantities of the comminuted polystyrene foam that were heaped on the surface. It was astounding to observe that the crude oil actually climbed up the heaps. Something of a suctioning effect was evident. With appropriately selected ratios, largely regularly shaped spherical structures resulted that looked black because of the crude oil. FIG. 3 depicts in greater detail the spherical structures obtained in this manner from the polystyrene foam absorbing the crude oil.

For further investigation, a razor blade was used to cut through a spherical structure made of the rigid polystyrene foam that was obtained in this manner and that had absorbed crude oil, and the cross-section was examined using an Olympus SZX 9 stereo microscope. In the microscope image the fine veining in the polystyrene granulate that absorbed the oil is very apparent, as is the crude oil mass pressing about a grain that has been cut through the middle. The image is at 32× magnification and is shown here in FIG. 4a. The same cross-section through such a spherical structure is shown in FIG. 4b, again as a microscope image created with the Olympus SZX 9 stereo microscope, but at 57× magnification; the details seen in FIG. 4a are even clearer in this image.

A razor blade was used to re-cut, at another location, the spherical structure resulting from the polystyrene granulate coated with rapeseed oil absorbing the crude oil, specifically such that a granulate grain located near the outside visible limit was cut. FIG. 5a is the resultant image, recorded at 32× magnification with the same microscope as above. In this image the penetration of the crude oil and its orientation on the granulate grain, comparable to the effect of a magnet on iron filings, is clearly visible. FIG. 5b provides the same image, but at 57× magnification, and illustrates even more clearly the phenomenon of the orientation of the crude oil toward the granulate grain.

The same views were also recorded using a Zeiss DSM 940 digital scanning electron microscope. They provide more details about the surface structure of the polystyrene granulate grain coated with rapeseed oil with crude oil arranged thereon and also provide more detailed information regarding the union between the polystyrene granulate grain and the crude oil.

In FIG. 6a, a first scanning electron microscope image of the cross-section through the spherical structure illustrates a 50× magnification of a granulate grain that is completely surrounded by the crude oil. The layered structure of the crude oil is clearly visible. Since the working voltage of the electron microscope used was 15,000 volts, the microscope's electron beams are able to penetrate the crude oil so that it appears white rather than black. FIG. 6b provides the same view, but at a 200× magnification. Although the visible segment of the surface of the crude oil bonded to the granulate grain is smaller, the stratification of the crude oil is even more clear.

Not only do these images made by a scanning electron microscope provide additional information about the intimate union between the crude oil and the polystyrene granulate coated with the rapeseed oil, but it is also possible to draw conclusions about the nature of the union between the granulate and the crude oil. As is known, it is not possible to obtain scanning electron microscope images unless a vacuum is created, into which vacuum the specimen to be examined is added. The DSM 940 microscope used here, which works in a magnification range of 5 to 100,000, uses a high vacuum of 10⁻⁴ Torr when imaging the specimens. If the union between the granulate and the crude oil drawn to it and therefore accumulated on it was only physical in nature, this union would not be able to hold under the high vacuum and consequently the crude oil would have to separate from the surface of the granulate and soil the very sensitive scanning electron microscope. Due to the fact that the spherical structure made of the rigid polystyrene foam that is formed by the absorption of the crude oil, or the part of the structure that was added to the high vacuum of the electron microscope for examining the cross-section, did not release any trace of the accumulated crude oil, it is clear that the union between the crude oil and the polystyrene granulate is not physical in nature at all, but rather is chemical in nature. Thus this is a true chemical bond, caused by adsorption, of all components involved.

In numerous experiments it was determined that, due to this adsorption union between the rigid polystyrene foam or the polystyrene granulate with the oil, and thus with the addition of oil to the capillary system of the polystyrene that is present in a cut up or fundamentally comminuted form, the inherent oil-binding ability is increased and above all absorption of moisture and water is prevented.

### Example 2

### Producing the Oil-Binding Agent

A rasp with a coarse file cut was used to cut up rigid polystyrene foam to a particle size between 0.5 to 1.5 mm. Alternatively, it can also be brushed.

The cutting involved substantial electrostatic charging of the comminuted granulate material, and this did not subside or disappear until the material had been sprayed with a vegetable oil. A series of tests were performed with a plurality of vegetable oils, and the following vegetable oils were tested successively, with increasing loading up to about 10 g vegetable oil per 100 g granulate:

Jojoba oil
Soya oil
Sunflower oil
Olive oil
Rapeseed oil.

It was demonstrated that static charge can be eliminated starting with a load of about 3 g per 100 g granulate.

The binding effect was examined in connection with raw crude oil. It was demonstrated that the best binding effect in terms of raw crude oil was obtained with about 8-10 g vegetable-oil coating per 100 g granulate material. Rapeseed oil proved to be the best vegetable oil, especially with respect to other product properties, such as the pourability of the bulk product.

### Example 3

### Long-Term Experiments in Spain

In the summer of 1992, about 250 g of bonded material was buried 50 cm deep in the ground, which comprised sand and gravel, east of Gerona, Spain, on the beach of the Costa Brava. The bonded material in this experiment comprised rigid polystyrene granulate that had been coated with about 8 g rapeseed oil per 100 g granulate and that had absorbed heavy oil having a density of 880 kg/m³. The resulting solid oil mass had a volume of about 300 cm³ and was shaped into 10×7×4 cm briquette-like blocks.

For environmental protection reasons, this bonded oil mass was not buried directly in the beach, but rather was placed in a stable plastic container that was filled with original gravel/sand soil from the Costa Brava beach. The plastic container filled with the bonded oil mass was then buried about 50 cm deep in the soil of the beach and the location was appropriately marked.

The material was dug up after three years. Due to changes in the soil caused by drifting sand and the formation of dunes, the storage depth had increased to about 75 cm from the original approximately 50 cm.

A vigorous decomposition process, approx. 70-80%, was found in the plastic container, initiated by microorganisms and soil bacteria. The soil area and the rest of the binding material were intact, i.e. none of the oil traveled into the surrounding soil or underground.

The residual quantity of the specimen that was dug up equaled about 70 g of bonded oil material, which was put through a meat grinder so that the residual heavy oil could be reclaimed.

### Example 3

### Long-Term Experiments in Belgium

In a manner similar to that explained in the foregoing under Example 2, in July 1991 another specimen was buried on the North Sea coast at Middlekerke, southwest of Ostende, about 100 m from the shore, directly adjacent to a tree in order to appropriately mark the location. In this experiment, however, about 250 g bonded light oil having a density of 830 kg/m³ was stored in the ground.

After a period of just over five years, the material was dug up in May 1995. Despite the low viscosity crude oil in the residual bond, a good 40% of the original weight was still present. The surrounding soil was oil-free, i.e. completely clean, and the adjacent tree was quite healthy. The bound oil was driven out of the residue using a meat grinder.

Overall the decomposition of the bound oil proceeded more slowly on the North Sea coast compared to the specimen on the Costa Brava, and this is apparently connected to the cooler climate on the North Sea compared to the warmer climate in Spain.

However, both experiments demonstrated that the oil-binding agent was quite ecofriendly. There was no contamination of the soil.

### Example 4

### Animal Experiment

This animal experiment came about accidentally during preparations for experiments on a closed soil covering at a gas station in Altforweiler, Saarland. The old oil that accumulated there from automobile oil changes was stored in a large vat that was disposed of periodically. A completely white duckling mistook the liquid in the vat for water and landed in the middle of the dirty used oil.

The severely oil-drenched bird was immediately placed in the oil-binding agent, and its feathers were rubbed dry with it and cleaned in this manner. Then the feathers were loosened with a blow dryer.

After this procedure the bird's feathers were not entirely white, but rather were somewhat gray. But the duck's life, and especially its ability to swim, had been saved.

It was easy to differentiate the duck that had been treated in this manner from other ducks because of this gray coloration, and the duck was observed for another two years on a pond at Überherr-Ludweiler. The duck was not found to have suffered any disabilities due to the oil accident at any time.

### Example 5

### Comparison Test on a Closed Road Surface

The inventive oil-binding agent was tested in comparison to the “Ecoperl” oil-binding agent that is available commercially.

A traffic accident that left a thick oil track on the road from Berus to Bisten, Saarland, provided the opportunity for the comparison.

When the inventive oil-binding agent was used it was possible to determine that all of the oil had been absorbed after a few minutes. The street was completely dry. No post-treatment was required. Oil absorption took much longer when using “Ecoperl” and it also required post-treatment in the form of thorough rinsing.

### Example 6

### Use of the Oil-Binding Agent for Countering an Oil Spill at Sea

Rigid polystyrene foam flakes that had been coated with about 8 g rapeseed oil per 100 g rigid polystyrene foam flakes in the manner described in the foregoing under Example 2 were applied to a crude oil spill at sea. The crude oil on the surface of the sea was incrementally absorbed by the rigid polystyrene foam flakes that had been coated with rapeseed oil. Due to the wave action of the sea, spheres formed after just a few hours, and primarily had a diameter of 2-4 cm.

The mixture of the rigid polystyrene foam flakes coated with rapeseed oil and the bound crude oil, i.e. the crude oil absorbed by the rigid polystyrene foam flakes, can float and can be easily fished out from the surface of the water. The crude oil remains captured. It was possible to prevent any contamination of the beach.

Analyses demonstrated that a sphere that is formed in this manner with the bound oil and that is about 4 cm in size has a volume of 33 cm³ and weighs 28-30 g, depending on the density of the crude oil.

### Example 7

### Producing the Oil-Binding Agent with a Filler

In order to increase the density of the inventive oil-binding agent, especially for applications outdoors, a filler is added to it, as FIG. 7 depicts in greater detail. A funnel-shaped supply, e.g. in the shape of a silo, is labeled 1 and contains cut or brushed rigid polystyrene foam 3. The funnel-shaped supply 1 releases the rigid polystyrene foam 3 into a pipe-shaped segment 5. There vegetable oil, in the illustrated embodiment rapeseed oil, is sprayed into the pipe-shaped segment 5 by means of an injection nozzle 7 and thus the rigid polystyrene foam 3 is coated with the vegetable oil. Then, further along in the pipe-shaped segment 5, a filler, silica sand 11 in the illustrated embodiment, is added by means of another nozzle 9 and in the pipe-shaped segment 5 mixes with the rigid polystyrene foam 3. A suction ventilator 13 ensures a continuous flow of granulate in the direction of a container 15 that is arranged beneath the pipe-shaped segment 5 and that receives the binding agent/filler mixture 3/11.

Foamed pearlite or another comparable filler can also be used instead of silica sands with different grain sizes.

The cut or alternatively brushed rigid polystyrene foam used in this illustrated embodiment has a particle size between 0.5 and 1.5 mm and is coated with about 8 g per 100 g granulate or rigid foam material.

Alternatively to application in loose form, it can also be provided that the inventive oil-binding agent is used packed in coverings. Pillows, mats, bags, or even tubes can be used. Thus for instance barriers can also be erected and further spreading of e.g. a crude-oil spill on the sea can be prevented effectively.

Compressed air, centrifuging, or ultrasound for instance can be used in order to drive out the oil that is to be disposed of and that was absorbed by the oil-binding agent for this purpose. It was demonstrated in experiments that at least about 90% of the bonded oil can be reclaimed in this manner. Even the oil-binding agent as such can be re-used for the same purpose.

1. An ecofriendly oil-binding agent based on comminuted plastic or an inorganic mineral that can be obtained as an adsorption union from the comminuted plastic or the inorganic mineral and at least one vegetable oil, vegetable oil constituent, or vegetable oil derivative.

2. The oil-binding agent in accordance with claim 1 wherein the plastic is polystyrene, preferably in a finely cut form.

3. The oil-binding agent in accordance with claim 1 wherein the vegetable oil is rapeseed oil, sunflower oil, soya oil, castor oil, olive oil, linseed oil, coconut oil, palm oil, or a constituent, derivative, or mixture thereof.

4. The oil-binding agent in accordance with claim 1, further comprising a filler.

5. Use of the oil-binding agent in accordance with claim 1 for binding oil on liquids, especially for binding oil on water.

6. The use in accordance with claim 5 for cleaning water in harbors or in containers filled with liquids.

7. The use of the oil-binding agent in accordance with claim 1 for cleaning oil-soaked living things.

8. The use of the oil-binding agent in accordance with claim 1 for binding oil on surfaces made of solids.

9. The use in accordance with claim 8 wherein the surfaces made of solids is a largely closed soil covering.

10. The use in accordance with claim 8 for cleaning oil containers.

11. The use in accordance with claim 8 wherein the surface made of solids is a soil that is largely made of movable solids.

12. The use in accordance with claim 5 wherein the oil to be bound is a crude oil or other residual oil.

13. The use of the oil-binding agent in accordance with claim 1 for capturing leak oil.

14. A method for disposing of oils that have a petrochemical or vegetable origin in which in a first method step a plastic or inorganic material is initially cut or finely divided and is allowed to react with at least one vegetable oil, vegetable oil constituent, or vegetable oil derivative in order to form an oil-binding agent through adsorption, and in which then in a second method step the plastic or mineral thus modified is allowed to further react with any oil, oil derivative, or oil constituent while largely completely absorbing the latter.
